(19) United States
(12) Patent Application Publication
(10) Pub. No.: US 2020/0380053 A1
(43) Pub. Date: Dec. 3, 2020

(54) METHOD AND DEVICE FOR SEARCHING FOR A PLACE

(71) Applicants: Morou Boukari, Toulouse (FR); PRODOSE SARL, Bessieres (FR)

(72) Inventor: Morou Boukari, Toulouse (FR)

(21) Appl. No.: 16/309,205

(22) PCT Filed: Sep. 2, 2016
(86) PCT No.: PCT/FR2016/052180

§ 371 Date: Aug. 16, 2020

(30) Foreign Application Priority Data
Jun. 14, 2016 (FR) 1655491

(51) Int. Cl. G06F 16/9535; G06F 16/9537

(52) U.S. Cl. CPC G06F 16/9535; G06F 16/9537

(57) ABSTRACT

The invention relates to a method for searching for a place on the basis of a free request for parameters defined by a user on a peripheral unit linked to a central unit, noteworthy in that it comprises the following steps: selection and grouping of types of parameters, spatial cutting of the terrestrial surface into area cells, said cells being associated with a plurality of sensors, said recorder sensors communicating with one another and/or by means of an aerial or spatial communication network, —association of data with a N parameter type and with an area cell so as to obtain data subsets, —processing of the data subsets, —construction of the free request, —analysis of the language and of the interpretation of the free request, —search for and selection of the area cells associated with the sorted and selected data, display of the place corresponding to the area cells found. The invention also relates to a device implementing said method. Applications: speeding up the search for a place.

### FIELD OF USE OF THE INVENTION

The present invention relates to the field of searching for a location and in particular to the adaptations allowing to carry out these searches in the best conditions.

### DESCRIPTION OF THE PRIOR ART

Usually, several days can be spent in order to obtain complete information on the destination of a location in particular for vacation. Indeed, today it is necessary to view a plurality of sources of information that are often incomplete and dispersed all over the world.

The document US2014279261 describes methods, systems and apparatuses comprising computer programs coded on computer storage media, intended for computer travel services. One of the methods comprises the following operations: receiving a trip query; identifying points of interest or destinations associated with a trip location; for each of the points of interest or of the destinations: determining photographs which are geographically associated with the point of interest or with the destination, selecting a photograph selected from the photographs; obtaining a description associated with the point of interest or with the destination, obtaining a hotel price associated with the point of interest or with the destination and obtaining a flight price for a flight corresponding to the point of interest or to the destination; and, for each of the points of interest or of the destinations, transmitting a result relative to the query comprising the respective selected photographs, description, hotel price and flight price.

This document does not precisely describe the technical features allowing to carry out the invention and in particular those allowing to provide the user with the data the user is seeking. Thus, although this document provides a natural language search, this language is used to give the name of the location or of the destination queried by the user but not to search for a location on the basis of the desired parameters.

### DESCRIPTION OF THE INVENTION

The applicants have thus carried out research with the goal of allowing any person, any institution or organization (civil or military) to locate and choose a location anywhere in the world in order to stay there, work there, etc. without knowing the name of this location but by emitting wishes or desires of what they might encounter, see, feel, experience, do, etc. there.

Another goal of the invention is to obtain this result very quickly and thus allow to save a lot of time by avoiding consulting a plurality of sources of information.

To do this, the applicants have imagined a new method for searching for a location on the basis of a free query for parameters defined by a user on at least one peripheral interrogation unit connected to at least one central unit for processing data, remarkable in that it comprises

a step of selection and of grouping together of types of parameters,

a step of spatial division of the Earth's surface into surface cells according to said selection and said grouping together, said cells being associated with a plurality of sensors that record identifiable parameters of said cells,

said recording sensors communicating with each other and/or by means of an aerial or spatial communication network, which network communicates with the at least one central unit,

a step of association of data at the output of the recording sensors with a type of parameters and with a surface cell in order to obtain subsets of data,

a step of processing of the subsets of data in the aforementioned at least one central unit,

a step of formation of the free query by the user on said at least one peripheral interrogation unit linked to the at least one aforementioned central unit,

a step of analysis of the language and of interpretation of the free query with identification of parameters or of type of parameters and generation of keywords and of the conditions for search, sorting and selection of said subsets of data,

a step of search and of selection of the surface cells associated with the sorted and selected data,

a step of display, on the aforementioned at least one peripheral interrogation unit, of the location(s) corresponding to the surface cells found.

The method thus proposes an inverted search. Such an inversion of the search allows to very rapidly provide, to the user of the method, a location or a plurality of locations corresponding to the parameters defined in the query by the user.

Thus, through only the expression of a desire or of wishes for example for activities, climatic, environmental, socioeconomic, political, military, security, strategic, health conditions, accommodation capacities, the user obtains one or more locations as a response.

According to another particularly advantageous feature of the invention, the free query is carried out in natural language. It is software that recognizes the words used in the query in order to generate keywords and/or in order to identify the parameters or the type of parameters.

In addition to the identification of quantifiable parameters, the software also recognizes in the query a value, a quantification that will be matched with the quantification of the parameters proposed by the recording sensors.

The method of the invention allows an acceleration of the searches and thus saves time. It also allows to carry out more complete searches.

It further allows to make visible throughout the entire world the touristic, economic and cultural advantages of each village, city and region of each country.

According to a commercially possible mode of use, the method of the invention associates and provides with the display of the destination according to the desires of the client, other data such as:
the possible means of transportation,
the available means of transportation,
the advantages of the means of transportation provided,
etc.

It thus appears that associated with the service proposed by the method for searching for a location inversely allowing to highlight one or more locations, the method ensures the visibility of other services associated with this or these locations.

These associated services will be able to justify the investment necessary for the deployment of the fleets of aircraft or of satellites that will form the aerial or spatial communication network providing the internet link necessary for the communication and/or the search of the data from the sensors.

There is a plurality of known technical means used to carry out the division of the Earth's surface such as the division proposed by the standard ISO 3166-1 alpha 2 or alpha 3 or alpha numeric. This international standard is used for the division of the world into countries with assignment of a code to each country. The standard ISO 3166-1 alpha 2 or alpha 3 or alpha numeric can be combined with the standard ISO 3166-2 which is used for the division of each country into subdivisions with assignment of a code to each subdivision.

The standard ISO 3166 (-1 and -2) is already used by banks for money transfers (bank code allowing to see where the bank is located), by airlines for the transport of the passengers and of the freight (country, city, airport code) and also for the sending of postal mail.

Another existing technical means for spatial division is that known under the name of NUTS (Nomenclature of Territorial Units for Statistics) and of the LAUs (Local Administrative Units). The LAUs are a subdivision of the NUTS. The NUTS are conventionally used by EUROSTAT and many other countries. The NUTS correspond, in a country, to the regions and the LAUs to the communes.

The techniques according to ISO 3166 (-1 and -2) or that of the NUTS and LAUs lead to the division of the Earth's surface into countries, of the countries into regions and of the regions into communes.

The size of the surface units varies according to the continents, according to the countries and according to the regions.

The invention does not therefore propose an assignment of the geographic coordinates (longitude, latitude, altitude) to a given location. This also does not involve the use of GPS or of the GIS (Geographic Information System) techniques known from the prior art and which use the geographic coordinates (longitude, latitude, altitude) for the storage of the data related to a point of interest.

According to the type of parameters, the division can be different and more or less precise. From the moment that, after a first search, a different division can be proposed, the software calls upon the user for more specifications related to said identified parameter(s) before displaying the location(s) identified as corresponding to the searched parameters.

Likewise from the moment that a quantification is possible and available according to the parameter identified in the query without this quantification itself being detected in the query, the software calls for more specifications related to the quantification of said parameter. Thus, according to another particularly advantageous feature of the invention, the method comprises the following operation:
proposing, to the user, once a first search has been carried out, quantifications for the identified parameters for purposes of optimization of the search.

According to another particularly advantageous feature of the invention, the method comprises the following operation:
proposing, to the user, once a first search has been carried out, types of parameters available but different than those identified in the user's query for purposes of optimization of the search.

This method requires the sorting, the parameterization and the storage of a large quantity of data. Thus, the applicants have advantageously imagined another feature of the method that is remarkable in that it comprises the creation of subsets of data each having the following data fields:
the geographic name(s) of the surface cell,
the type of parameter associated with said surface cell,
the nature of said parameter,
the quantification of said parameter,
the temporal validity of the quantification of said parameter,
the date/time of updating of the previous fields,
the source/the origin of the fields filled out.

According to another particularly advantageous feature of the invention, the method comprises an operation of storage of the subsets of data in the aforementioned at least one central unit. The sensors thus communicate all of the data to the central unit.

According to another particularly advantageous feature of the invention, the method comprises an operation of storage of the data in a storage module associated with each sensor. The sensors are thus the custodians of the data searched and the central unit ensures their interrogation.

The type of parameters depends on the recording sensors present in said surface cells and on the data that they are capable of providing.

Thus, according to a particularly advantageous feature of the invention, these sensors are sensors measuring parameters of the meteorological type like:
sensors for measurement of temperature,
sensors for measurement of humidity,
sensors for measurement of atmospheric pressure,
sensors for measurement of rain,
sensors for measurement of sunshine,
sensors for measurement of wind speed,
sensors for measurement of snow cover,
sensors for measurement of the height of waves,
etc.

Associated or not associated with these data sensors, other sensors that can be qualified as qualitative, measure other parameters like:
sensors for measurement of the pollution of the air,
sensors for measurement of the pollution of the water,
sensors for measurement of visits to locations,
sensors for measurement of lack of security,
sensors for measurement of health risk related to food,
sensors for reception of aerial flight data for reservations,
etc.

The various subsets of data formed by the data resulting from the taking of measurements of said sensors ensure the user that the various parameters of the user's query are taken into account.

In order to obtain a search result that goes beyond a search for a vacation location but also in order to complete the latter, the applicant has advantageously imagined the creation of new subsets of data.

Thus, according to another particularly advantageous feature, the type of parameter is political. Indeed, it is accepted to note that the destinations proposed and the destinations to which it is for example dangerous to go to may not match up. Such a difference requires the viewing of a plurality of sites of data (for example a travel site and a site of the foreign ministry). The invention allows to have available this type of resource in order to avoid the viewing of a plurality of sites.

According to another particularly advantageous feature, the type of parameter is military. Indeed, for military missions, it is important to know whether there are, at the location at which it is planned to carry out military operations with optional rapid withdrawal of the troops:
a military base of the country of origin of the troops, a military base of a friendly country, a military base of an enemy country,
logistical support cells of the country of origin of the troops, logistical support cells of a friendly country, logistical support cells of an enemy country,
intelligence officers of the country of origin of the troops, intelligence officers of a friendly country, intelligence officers of an enemy country;
hostilities of the local populations with regard to the nationals of the country of origin of the troops.

According to another particularly advantageous feature, the type of parameter is educational. Such a subset of data can respond to queries concerning a request for training.

According to another particularly advantageous feature, the type of parameter is health-related. Such a subset of data can complete the responses to the queries requiring the presence of vaccine.

According to another particularly advantageous feature, the type of parameter is administrative. Such a subset of data can complete the responses to the queries requiring administrative formalities.

According to another particularly advantageous feature, the type of parameter is security-related.

According to another particularly advantageous feature, the type of parameter is geopolitical and strategic.

According to another particularly advantageous feature, the type of parameter is environmental.

The invention also relates to the device allowing to implement said method and which is remarkable in that it comprises at least one server for storing and managing said subsets of data with which modules for input of data provided by the recording sensors and modules for searching in said subsets of data communicate.

This server is connected by a digital network to at least one client computer provided with an artificial intelligence for analysis and interpretation of the free query allowing it to interact with the user in order to collect a string of characters representing the user's free query and also to provide the user with results in the form of multimedia documents (text, animated or non-animated images, sound, 3D representation, etc.).

More precisely, the device comprises at least one unit called server containing subsets of data organized into bytes, each byte being composed in particular of the data listed above for the subsets described above.

According to another feature, the device is remarkable in that each surface cell or set of surface cells comprises a plurality of sensors that record at least one identifiable parameter.

According to another particularly advantageous feature of the invention, said aerial communication network consists of a fleet of aircraft transporting a communication module in order to dialogue with each other, communicate with the at least one central unit and receive the data from said sensors.

According to another particularly advantageous feature of the invention, said spatial communication network consists of a fleet of satellites disposed in low Earth orbit transporting a communication module in order to dialogue with each other, communicate with the at least one central unit and receive the data from said sensors.

According to another particularly advantageous feature of the invention, said sensors are equipped with a module for storing the data.

The examples of technologies capable of implementing the measurement of the parameters described above are numerous. Nevertheless, among these, the applicants have carried out the selection of the following devices.

In order to implement the measurement of rain, the device of the invention comprises, in the surface cell, a sensor measuring the variations of a light ray due to the refraction caused by the presence of water.

In order to implement the measurement of sunshine, the device of the invention comprises a network of photodiodes disposed according to a particular geometry measuring the radiation. The use of a plurality of photodiodes ensures that at least one directly receives the solar radiation and allows a precise measurement under any conditions. At least one photodetector receives the light directly from the sun (in addition to the diffuse component), the photodiodes that are not directly illuminated by the sun, are used for the measurement of the diffused light which is subtracted from the measurement of the sensor that directly sees the sun in order to obtain the direct radiation.

In order to implement the measurement of snow cover, the device of the invention comprises a satellite which, carrying optical sensors, produces images of the snow cover of the surface cell in question. The sensor is not therefore physically present in the surface cell. The images obtained are processed by various algorithms in order to determine the snow cover.

In association or not with the previous feature in order to carry out the same function, the device of the invention comprises a distance sensor measuring the delay between the emission and the reception of an acoustic pulse emitted thus allowing to measure the thickness of a layer of snow.

In order to implement the measurement of wind speed, the device comprises a weather vane module associated with a horizontal wind turbine. According to another technology, the device comprises a probe for measurement of temperature on which the cooling effect caused by the wind is measured.

In order to implement the measurement of the height of the waves, the device comprises a submerged acoustic current profiler. Associated or not associated with the previous feature in order to carry out the same function, the device further comprises a submerged velocimeter and/or a current meter.

In order to implement the measurement of the quality or of the pollution of the water and participate in the parameter of the environmental type, the device comprises capillary tubes made of glass provided with specific antibodies and LEDs used in medical imaging for purposes of detection of Escherichia coli bacteria. Other detection modules are capable of testing the presence of heavy metals such as mercury, iron, arsenic, chromium, lead or cyanide in the water.

According to another feature, the device comprises a multifunction probe simultaneously analyzing thirteen parameters.

There are also prepositioned measurement stations for the measurement of the quality of the surface water which, forming networks, are capable of being used for the implementation of the invention.

In order to implement the measurement of the pollution of the air, there is a plurality of technical means for measurement of indicators characteristic of the quality of the air like:
the quantity of Volatile Organic Compounds,
the concentration of carbon dioxide,
the concentration of carbon monoxide,
the concentration of fine particles,
the temperature,
the relative humidity,
the dust,
nitrogen dioxide,
ozone,
sulfur dioxide,
the quantity of pollen.

Like for the quality of the water, there are already prepositioned stations for measurement of the quality of the air which, forming networks, are capable of being used for the implementation of the invention.

According to another feature of the invention, the device comprises a sensor for reception of aerial data.

According to another feature of the invention, the device comprises a sensor recording flight offers from the airlines.

In order to provide data on less-usual parameters in the context of a search for a destination, the invention further comprises original sensors providing information on original parameters.

Thus, for example, in order to implement the measurement of visits, the device comprises a module for geolocation of the tourists which allows to know their positions and their movements. This location module can comprise a sensor associated with each tourist or depend on a mobile application. The visit data can also be provided by the establishments welcoming said tourists.

According to another technology, the device comprises a camera associated with software for detection of the presence of a human face. It is thus possible to provide data on visits and movement of the people detected for purposes of implementing the method of the invention.

According to another feature, the device comprises a network of small video sensors placed at certain key places, associated with software for detection of the presence of a human face.

According to another feature, the device comprises a sensor detecting around it, the presence of mobile telephones ensuring the providing of data on visits to a location.

In order to implement the measurement of the lack of security in a surface cell and participate in the parameter of the security type, there are applications for mobile telephones that give information on the level of lack of security according to the geolocation and the time of day. Such an application is based on public data and reports from the bodies tasked with security. This data can be used directly or via the application in order to provide this parameter for the implementation of the invention.

According to another feature, the device comprises a camera coupled with software for behavioral analysis in order to identify suspicious behavior.

In order to implement the measurement of the food insecurity in a surface cell, the device comprises a sensor allowing to detect the molecules produced during the decomposition of the food (ethanol, biogenic amines, etc.) in the packaging of the food present in said surface cell. According to another feature this sensor is a radiofrequency tag of the RFID type.

According to another feature, the sensor measures the permittivity of the food for purposes of determination of whether the permittivity measured corresponds to that of a fresh food or to that of a contaminated food.

It appears that a plurality of technical means is capable of providing all or a portion of the searched parameters. These technical means can be already prepositioned on the surface cells and thus be used for this new function namely the providing of data capable of responding to the queries of the users of the method of the invention. Likewise, a plurality of measurement means is capable of providing data relating to a plurality of the searched parameters, without all of them being used. It is not therefore necessary to install a sensor dedicated to each searched parameter.

It is further understood that, according to the parameter measured, the sensors provide data relating to a single surface cell or a plurality.

Moreover, it appears that a plurality of parameters is capable of being measured or recorded using mobile modules that can be connected to or are integrated into mobile telephones. Since these telephones can be geolocated, it is thus possible to have available for surface cells in question, geolocated measured data.

Finally, most of the sensors can be connected to a network in order to store the data measured and make it available.

The fundamental concepts of the invention just disclosed above in their most basic form, other details and features will be clearer upon reading the following description and in comparison to the appended drawings, giving as a non-limiting example, an embodiment of a device according to the invention.

### BRIEF DESCRIPTION OF THE DRAWINGS

FIG. 1 is a diagram of an embodiment of a digital network according to the invention,

FIG. 2 is a diagram illustrating the structure of the subsets of data on one type of parameters,

FIG. 3 is a diagram illustrating the structure of the subsets of data on another type of parameters,

FIG. 4 is a diagram illustrating the structure of the subsets of data on another type of parameters,

FIG. 5 is a diagram illustrating the structure of the subsets of data on another type of parameters,

FIG. 6 is a diagram illustrating the structure of the subsets of data on another type of parameters,

FIG. 7 is a diagram illustrating the structure of the subsets of data on another type of parameters,

FIG. 8 is a diagram illustrating the structure of the subsets of data on another type of parameters,

FIG. 9 is a diagram illustrating the structure of the subsets of data on another type of parameters,

FIG. 10 is a diagram illustrating the structure of the subsets of data on another type of parameters,

FIG. 11 is a diagram illustrating the structure of the subsets of data on another type of parameters.

### DESCRIPTION OF A PREFERRED EMBODIMENT

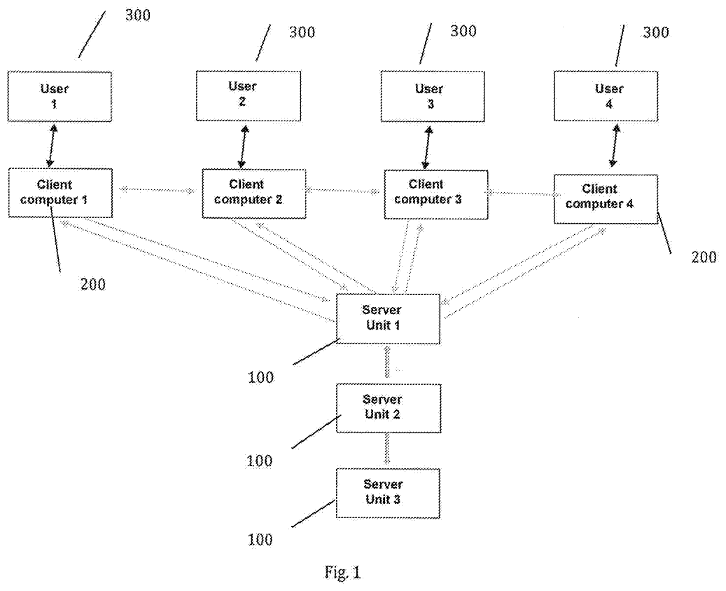

As illustrated in the drawing of FIG. 1, the device for inverted search is composed of at least one unit called server 100 (here 3) containing a specific database of documentary data, connected by a digital network to at least one client computer 200 provided with an artificial intelligence for analysis and interpretation allowing it to interact with the user 300 in order to collect a string of characters representing the user's free query and also to provide the user with results in the form of multimedia documents (text, static images, animated images, sound, 3D representation, etc.).

The data of the specific database of documentary data of the server unit is in the form of subsets of data each forming a septuple, each septuple being composed of:
A surface cell noted as S1 (not shown), resulting from the spatial division of the globe into elementary units,
The type of the parameter noted as S2 associated with the surface cell S1,
The nature of the parameter noted as S3,
The quantification of the parameter noted as S4,
The temporal validity of the quantification of the parameter noted as S5 (not shown),
The date/time of updating of the quintuple (S1, S2, S3, S4, S5) noted as S6 (not shown),
The source of this quintuple (S1, S2, S3, S4, S5) noted as S7 (not shown).

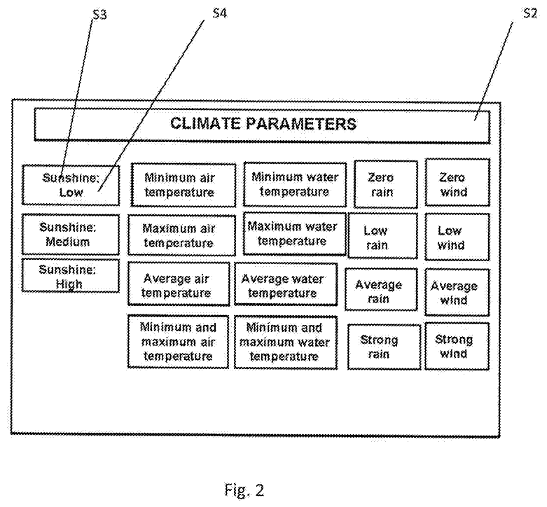

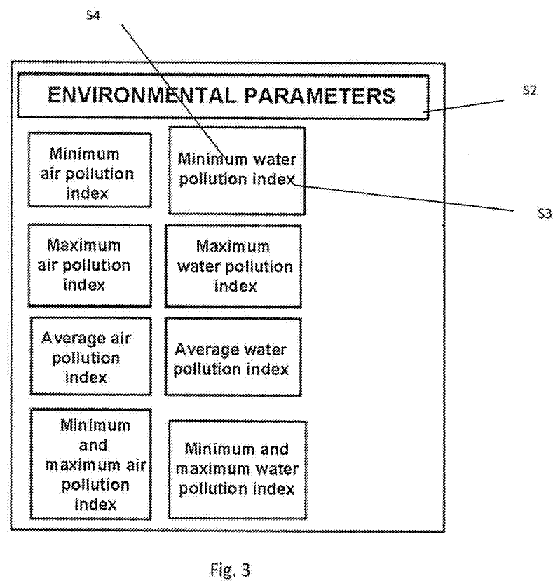

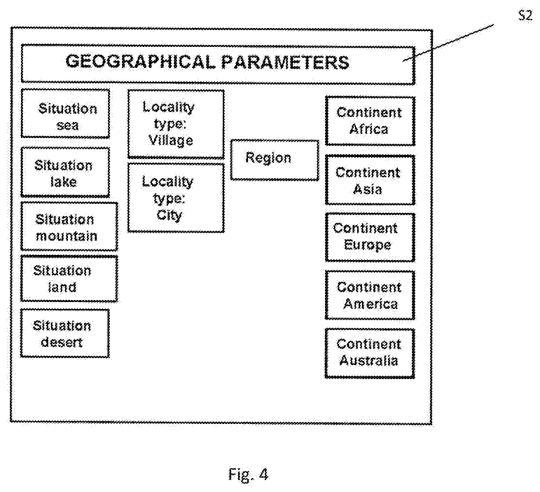

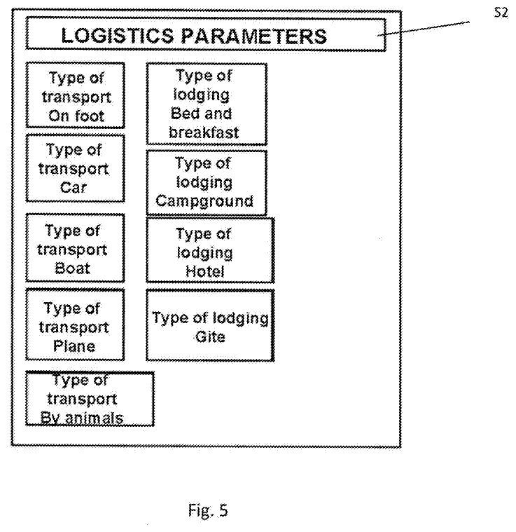

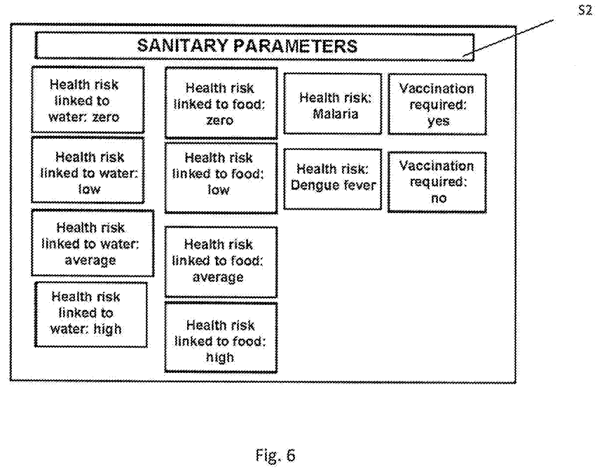

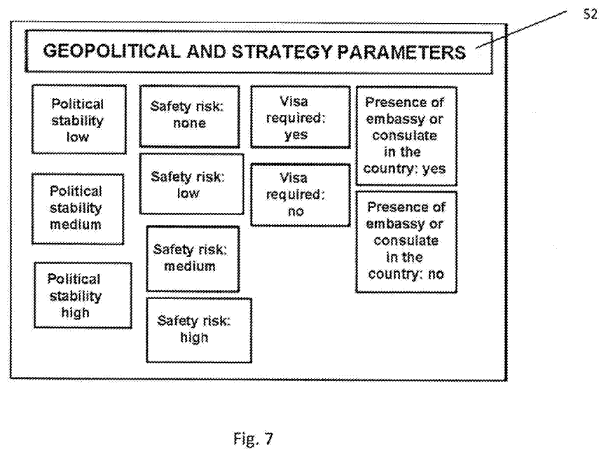

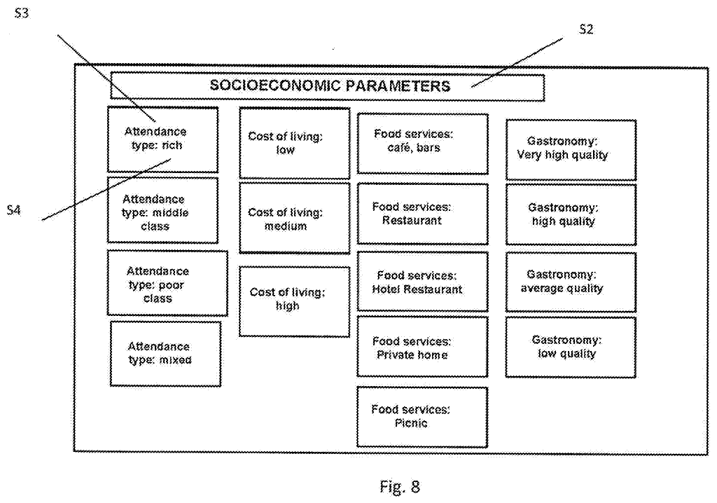

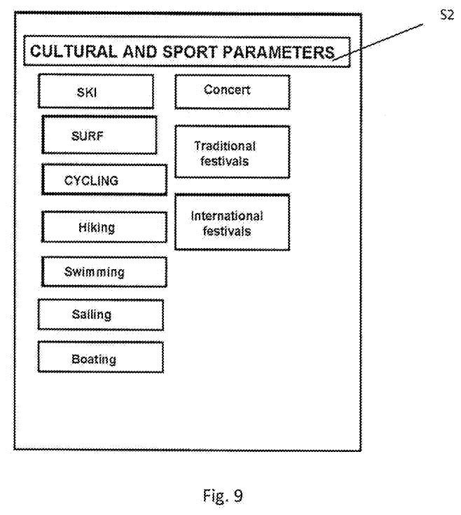

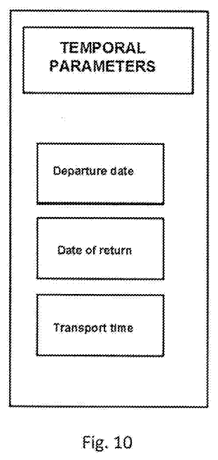

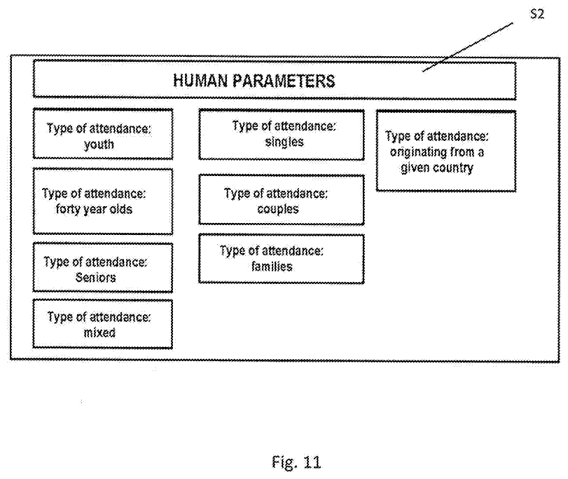

The drawings of FIGS. 2 to 11 illustrate the levels S2, S3 and S4.

The analysis and interpretation of the free query at the level of the peripheral unit or the client computer is carried out by the search for relevant elements via the presence in the artificial intelligence program of one or more series of scripts allowing to find strings of characters corresponding to an unequivocal descriptive syntax. For each relevant element identified, the client computer generates conditions of the query for search, selection and sorting in the database of the subsets of data contained in the central unit for processing data or server computer. The following parts explain how, via the existence of a documentary database, the structure of which is explained, a search for the relevant elements of a query of the user can be carried out via a suitable translation.

Thus, on the basis of the structure described above, each subset of data constitutes a byte of seven sections thus a septuple composed of S1, S2, S3, S4, S5, S6 and S7, spread out in the following manner:

S1: surface cell;

S2: type of the parameter;

S3: property of the parameter;

S4: quantification of the parameter;

S5: temporal validity of the quantification of the parameter;

S6: date/time of updating of this quintuple;

S7: source of this quintuple.

An example of subset of data can be:

(Toulouse; Climatic parameter; air temperature; 25° C.; 15 Jun. 2015 14:00-15 Jun. 2015 15:00; Météo-France forecast)

Another example can be:

(Toulouse; Cultural parameter; Reputation of food; good; 2014; Michelin Guide).

An example of search for relevant elements in the text of the free query (in the client computer) is described below:

Thus, for a free query of the user worded in the following manner:

“I would like to go somewhere with good weather with an air temperature of 25° C. with good cuisine.”

A series of scripts allows to find the strings of characters corresponding to an unequivocal descriptive syntax.

The simplest case relates to the strings of characters. “Good weather” or “good food”.

A more complex case relates to the temperature. It is detected in the text when a series of digits precedes the strings “° C.” or “° F.” or “° K”.

The translation into queries on the subsets of data is described below.

For each relevant element identified, conditions of the query for search in the database of the subsets of data are generated.

Example 1: the relevant element “good weather” is converted into the following condition:

S3=“Air temperature” AND S4>=20° C.

Example 2: the relevant element “good food” is converted into the following condition:

S3=“Reputation of food” AND (S4=“good” OR S4=“superior” OR S4=“excellent”)

The syntaxes of elements of conditions of queries presented above are known from the databases SQL (structured query language) and NoSQL (system for database management that is not based on the conventional architecture of relational databases).

The invention allows to have a response available in less than a minute.

One of the responses to this free query could be:

“Toulouse, France; air temperature; 25°; 15 Jun. 2015 14:00-30 Jun. 2015 15:00”

It is understood that the method and the device, which were just described and represented above, were described and represented with a view to disclosure rather than limitation. Of course, various arrangements, modifications and improvements can be made to the above example, without actually going beyond the context of the invention.

1. Method for searching for a location on the basis of a free query for parameters defined by a user on at least one peripheral interrogation unit connected to at least one central unit for processing data, characterized in that it comprises
a step of selection and of grouping together of types of parameters,
a step of spatial division of the Earth's surface into surface cells according to said selection and said grouping together of parameters, said cells being associated with a plurality of sensors that record identifiable parameters of said cells,
said recording sensors communicating with each other and/or by means of an aerial or spatial communication network, which network communicates with the aforementioned at least one central unit,
a step of association of data at the output of the recording sensors with a type of parameters and with a surface cell in order to obtain subsets of data,
a step of processing of the subsets of data in the aforementioned at least one central unit,
a step of formation of the free query by the user on the aforementioned at least one peripheral interrogation unit linked to the aforementioned at least one central unit,
a step of analysis of the language and of interpretation of the free query with identification of parameters or of type of parameters and generation of keywords and of the conditions for search for sorting of data and selection of said subsets of data,
a step of search and of selection of the surface cells associated with the sorted and selected data,
a step of display, on the aforementioned at least one peripheral interrogation unit, of the location(s) corresponding to the surface cells found.

2. Method according to claim 1, characterized in that it comprises the following step:
proposing, to the user, once a first search has been carried out, types of parameters available but different than those identified in the user's query for purposes of optimization of the search.

3. Method according to claim 1, characterized in that it comprises the following step:
proposing, to the user, once a first search has been carried out, quantifications for the identified parameters for purposes of optimization of the search.

4. Method according to claim 1, characterized in that it comprises the following step:
storage of the subsets of data in the aforementioned at least one central unit.

5. Method according to claim 1, characterized in that it comprises the following step:
storage of the data in a storage module associated with each sensor.

6. Method according to claim 1, characterized in that it comprises the creation of subsets of data each having the following data fields:
the geographic name(s) of the surface cell,
the type of parameter associated with said surface cell,
the nature of said parameter,
the quantification of said parameter,
the temporal validity of the quantification of said parameter,
the date/time of updating of the previous fields,
the source/the origin of the fields filled out.

7. Method according to claim 6, characterized in that the type of parameter is political.

8. Method according to claim 6, characterized in that the type of parameter is educational.

9. Method according to claim 6, characterized in that the type of parameter is health-related.

10. Method according to claim 6, characterized in that the type of parameter is military.

11. Method according to claim 6, characterized in that the type of parameter is geopolitical and strategic.

12. Method according to claim 6, characterized in that the type of parameter is administrative.

13. Method according to claim 6, characterized in that the type of parameter is security-related.

14. Method according to claim 6, characterized in that the type of parameter is environmental.

15. Method according to claim 1, characterized in that the free query is carried out in natural language.

16. Device allowing to implement the method for searching for a location on the basis of a free query for parameters defined by a user on at least one peripheral interrogation unit connected to at least one central unit for processing data according to claim 1 of the type of that comprising
a step of selection and of grouping together of types of parameters,
a step of spatial division of the Earth's surface into surface cells according to said selection and said grouping together of parameters, said cells being associated with a plurality of sensors that record identifiable parameters of said cells,
said recording sensors communicating with each other and/or by means of an aerial or spatial communication network, which network communicates with the at least one central unit,
a step of association of data at the output of the recording sensors with a type of parameters and with a surface cell in order to obtain subsets of data,
a step of processing of the subsets of data in the aforementioned at least one central unit,
a step of formation of the free query by the user on the aforementioned at least one peripheral interrogation unit linked to the aforementioned at least one central unit,
a step of analysis of the language and of interpretation of the free query with identification of parameters or of type of parameters and generation of keywords and of the conditions for search for sorting of data and selection of said subsets of data,
a step of search and of selection of the surface cells associated with the sorted and selected data,
a step of display, on the aforementioned at least one peripheral interrogation unit, of the location(s) corresponding to the surface cells found,
characterized by the fact that it comprises at least one server for storing (100) and managing said subsets of data with which modules for input of data provided by the recording sensors and modules for searching in said subsets of data communicate, said server being connected by a digital network to at least one client computer (200) provided with an artificial intelligence for analysis and interpretation of the free query allowing it to interact with the user (300) in order to collect a string of characters representing the user's free query and also to provide the user with results in the form of multimedia documents (text, static images, animated images, sound, 3D representation, etc.).

17. Device according to claim 16, characterized by the fact that each surface cell or set of surface cells comprises a plurality of sensors that record at least one identifiable parameter.

18. Device according to claim 16, characterized by the fact that said aerial communication network consists of a fleet of aircraft transporting a communication module in order to dialogue with each other, communicate with the at least one central unit and receive the data from said sensors.

19. Device according to claim 16, characterized by the fact that said spatial communication network consists of a fleet of satellites disposed in low Earth orbit transporting a communication module in order to dialogue with each other, communicate with the at least one central unit and receive the data from said sensors.

20. Device according to claim 16, characterized by the fact that said sensors are equipped with a module for storing the data.
